(19) United States
(12) Patent Application Publication
(10) Pub. No.: US 2026/0346719 A1
(43) Pub. Date: Nov. 5, 2026

(54) VEHICLE INSTRUMENT PANEL

(71) Applicant: Textron Inc., Providence, RI (US)

(72) Inventors: Benjamin Joseph Garten, Providence, RI (US); Matthew Daniel Wilson, Providence, RI (US); Christopher Kenneth Furman, Providence, RI (US)

(21) Appl. No.: 19/306,147

(22) Filed: Aug. 21, 2025

Related U.S. Application Data
(63) Continuation-in-part of application No. 30/002,036, filed on May 1, 2025, now Pat. No. D1144258.
(63) Continuation-in-part of application No. 30/002,038, filed on May 1, 2025, now Pat. No. D1132216.
(63) Continuation-in-part of application No. 30/002,035, filed on May 1, 2025, now Pat. No. D1144257.
(63) Continuation-in-part of application No. 30/002,037, filed on May 1, 2025, now Pat. No. D1132828.

(51) Int. Cl. B60K 37/20; B60J 1/02; B60K 35/22; B60R 7/06; B62D 25/08

(52) U.S. Cl. CPC B60K 37/20; B60J 1/02; B60K 35/22; B60R 7/06; B62D 25/081; B60K 2360/65

(57) ABSTRACT

An instrument panel assembly for a vehicle includes an instrument panel body and a lower housing. The instrument panel body includes an upper surface defining a housing for receiving an display and a lower surface defining an opening to the housing. The display is configured to be inserted through the opening. When the instrument panel body is installed in the vehicle the upper surface is visible to a passenger. The upper surface is configured to appear as a continuous unbroken surface. The lower housing is configured to receive a controller for the display. The lower housing coupled to the lower surface of the instrument panel body. The display is received within the housing without any external trim pieces shrouding edges of the display

### CROSS-REFERENCE TO RELATED PATENT APPLICATIONS

This application is a continuation-in-part of (a) U.S. patent application Ser. No. 30/002,035, filed May 1, 2025, (b) U.S. patent application Ser. No. 30/002,036, filed May 1, 2025, (c) U.S. patent application Ser. No. 30/002,037, filed May 1, 2025, and (d) U.S. patent application Ser. No. 30/002,038, filed May 1, 2025, each of which is incorporated herein by reference in its entirety.

### BACKGROUND

Vehicles, such as golf carts, may include vehicle instrument panels. The vehicle instrument panels provide drivers with information about the vehicle's status and performance and hold accessories. Many existing solutions involve bolting on components or inserting displays through openings and covering them with trim pieces. This approach may lead to a time intensive installation process, visible seams, and a disjointed appearance, detracting from the overall perceived quality of the vehicle interior.

### SUMMARY

One embodiment relates to an instrument panel assembly for a vehicle. The instrument panel assembly includes an instrument panel body and a lower housing. The instrument panel body includes an upper surface defining a housing for receiving a display and a lower surface defining an opening to the housing. The display is configured to be inserted through the opening. When the instrument panel body is installed in the vehicle the upper surface is visible to a passenger. The upper surface is configured to appear as a continuous unbroken surface. The lower housing is configured to receive a controller for the display. The lower housing coupled to the lower surface of the instrument panel body. The display is received within the housing without any external trim pieces shrouding edges of the display.

Another embodiment relates to an instrument panel assembly for a vehicle, the instrument panel assembly includes and instrument panel body, a lower housing, and an display retainer. The instrument panel body includes an upper surface defining a housing for receiving a display and a lower surface defining an opening to the housing. The display is configured to be inserted through the opening. When the instrument panel body is installed in the vehicle the upper surface is visible to a passenger. The lower housing is configured to receive a controller for the display. The lower housing is coupled to the lower surface of the instrument panel body. The controller is positioned under the display to enable the controller to be electrically coupled to the display. The display retainer is received within the opening and disposed above the lower housing. The display retainer is configured to couple the display to the instrument panel body.

Still another embodiment relates to a vehicle. The vehicle includes a frame, a cowl coupled to the frame, a windshield coupled to the frame, and an instrument panel assembly coupled to the cowl. The instrument panel assembly includes an instrument panel body and a lower housing. The instrument panel body includes an upper surface defining a housing for receiving an display and a lower surface defining an opening to the housing. The housing includes a first surface defining a second opening configured to enable a passenger to access the display and a second surface defining a recess. The second surface is opposite the first surface. The second surface is configured to confront the windshield. The recess is configured to receive an attachment. The display is configured to be inserted through the opening. The lower surface includes one or more prongs extending from an edge of the instrument panel body. The prongs are configured to couple to the cowl. When the instrument panel body is installed in the vehicle the upper surface is visible to the passenger. The lower housing is configured to receive a controller for the display. The lower housing is coupled to the lower surface of the instrument panel body.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a perspective view of the vehicle of FIG. 1 including an instrument panel assembly, according to an exemplary embodiment.

FIG. 5 is an exploded view of the instrument panel assembly of FIG. 4 including an instrument panel body, an intermediate housing, a lower housing, and a controller, according to an exemplary embodiment.

FIG. 6 is a cross-sectional view of the instrument panel assembly of FIG. 4 taken along plane A-A, according to an exemplary embodiment.

FIG. 7 is a bottom perspective view of the instrument panel assembly of FIG. 4, according to an exemplary embodiment.

FIG. 8 is a detailed view of DETAIL A in FIG. 6, according to an exemplary embodiment.

FIG. 9 is a perspective view of the instrument panel assembly of FIG. 4, according to an exemplary embodiment.

FIG. 10 is detailed view of DETAIL B in FIG. 9, according to an exemplary embodiment.

FIG. 11 is bottom view a portion of the instrument panel assembly of FIG. 4, according to an exemplary embodiment.

FIG. 12 is top view of the instrument panel body of FIG. 5, according to an exemplary embodiment.

FIG. 13 is bottom view of the instrument panel body of FIG. 5, according to an exemplary embodiment.

FIG. 14 is a front view of the instrument panel body of FIG. 5, according to an exemplary embodiment.

FIG. 15 is a rear view of the instrument panel body of FIG. 5, according to an exemplary embodiment.

FIG. 16 is a side view of the instrument panel body of FIG. 4, according to an exemplary embodiment.

FIG. 17 is a perspective view of the intermediate housing of FIG. 5, according to an exemplary embodiment.

FIG. 18 is a front view of the intermediate housing of FIG. 5, according to an exemplary embodiment.

FIG. 19 is a top view of the intermediate housing of FIG. 5, according to an exemplary embodiment.

FIG. 20 is a perspective view of the lower housing of FIG. 5, according to an exemplary embodiment.

FIG. 21 is a front view of the lower housing of FIG. 5, according to an exemplary embodiment.

FIG. 22 is a side view of the lower housing of FIG. 5, according to an exemplary embodiment.

FIG. 23 is a rear view of the lower housing of FIG. 5, according to an exemplary embodiment.

FIG. 24 is a top view of the lower housing of FIG. 5, according to an exemplary embodiment.

FIG. 25 is rear perspective view of a portion of the instrument panel assembly of FIG. 4, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

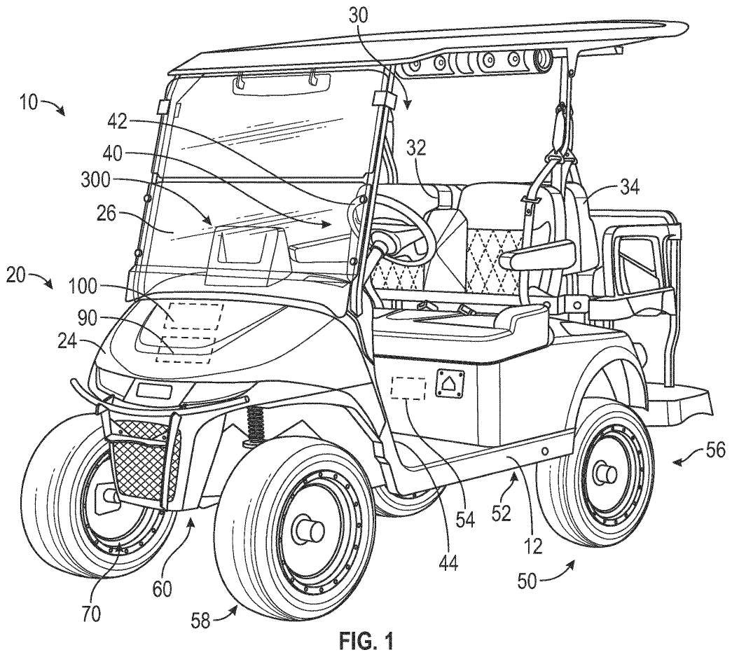

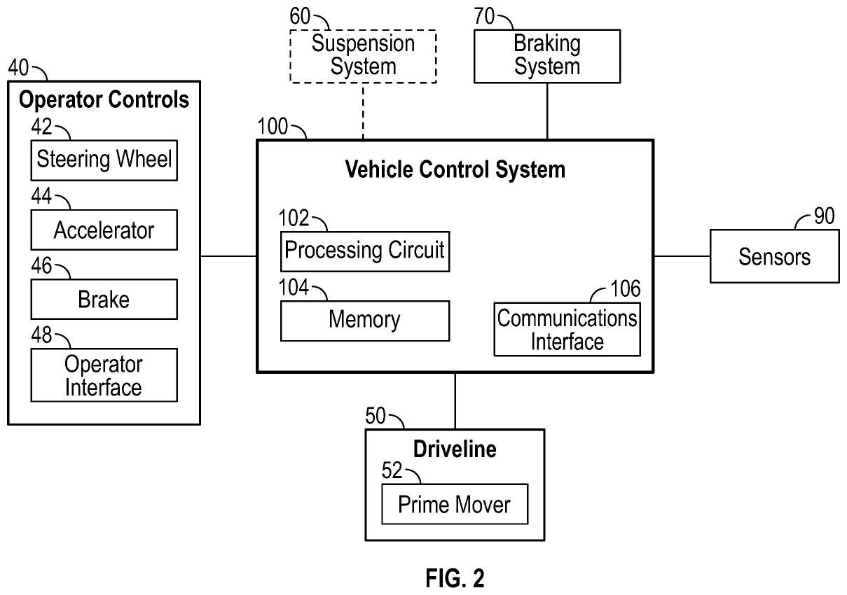

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; a housing, shown as cowl 24 coupled to the frame 12; a front window, shown as windshield 26, coupled to the frame 12; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

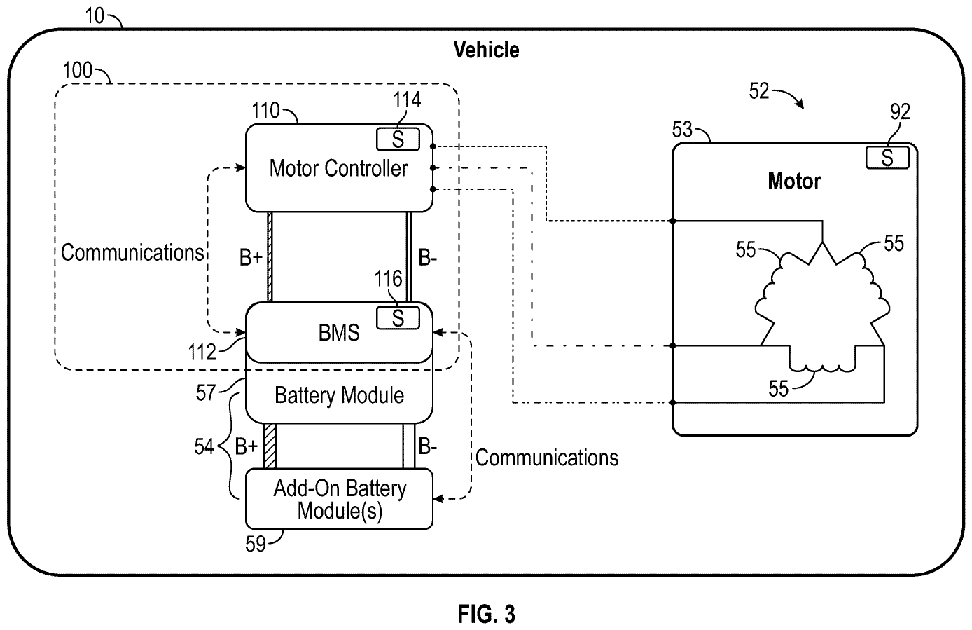

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., a remote systems) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Instrument Panel

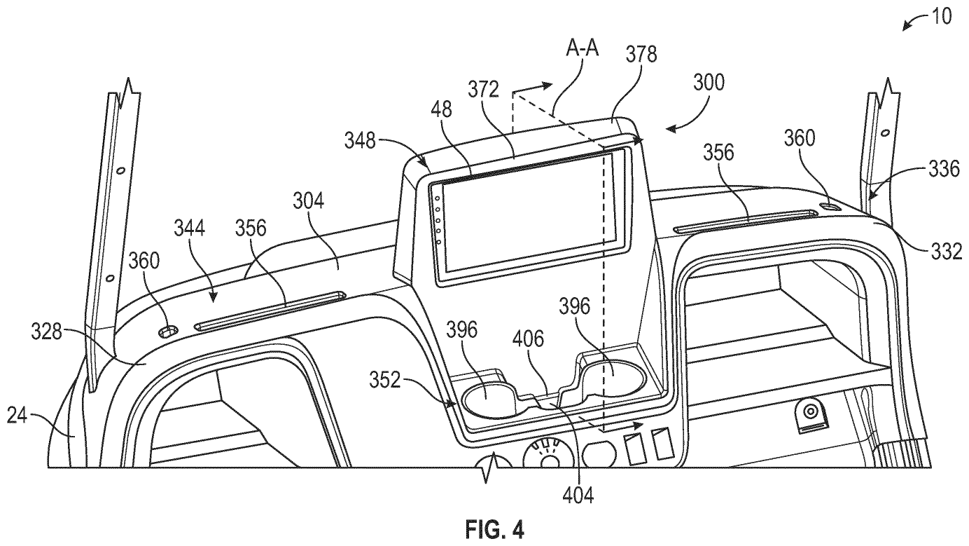

As shown in FIG. 4, the vehicle 10 includes an instrument panel assembly, shown as panel assembly 300. The panel assembly 300 may be coupled the cowl 24 to create a seamless visual appearance. As shown in FIG. 4-7, the panel assembly 300 includes an instrument panel body, shown as panel body 304; the operator interface 48 (e.g., a display screen a touchscreen, etc.); an operator interface bracket or retainer, shown as intermediate housing 312; an operator interface processor, shown as controller 320; and a controller housing, shown as lower housing 316. The panel body 304 is configured to receive the operator interface 48 and the intermediate housing 312 is configured to hold (e.g., retain, wedge, etc.) the operator interface 48 within the panel body 304. The lower housing 316 couples to the panel body 304 and is configured to receive the controller 320 to align or position the controller 320 underneath (e.g., directly underneath) the operator interface 48. The controller 320 is configured to manage the functions of the operator interface 48 (e.g., process and control the operator interface 48, etc.). As shown in FIG. 4, the intermediate housing 312, the controller 320, and the lower housing 316 are obscured from a passenger's view by the panel body 304 when the panel assembly 300 is coupled to the cowl 24. The panel body 304 and the operator interface 48 are visible to the passenger when the panel assembly 300 is coupled to the cowl 24. In some embodiments, the panel body 304, the intermediate housing 312, and the lower housing 316 are each injection molded plastic. Each of the panel body 304, the intermediate housing 312, and the lower housing 316 are described in further detail below.

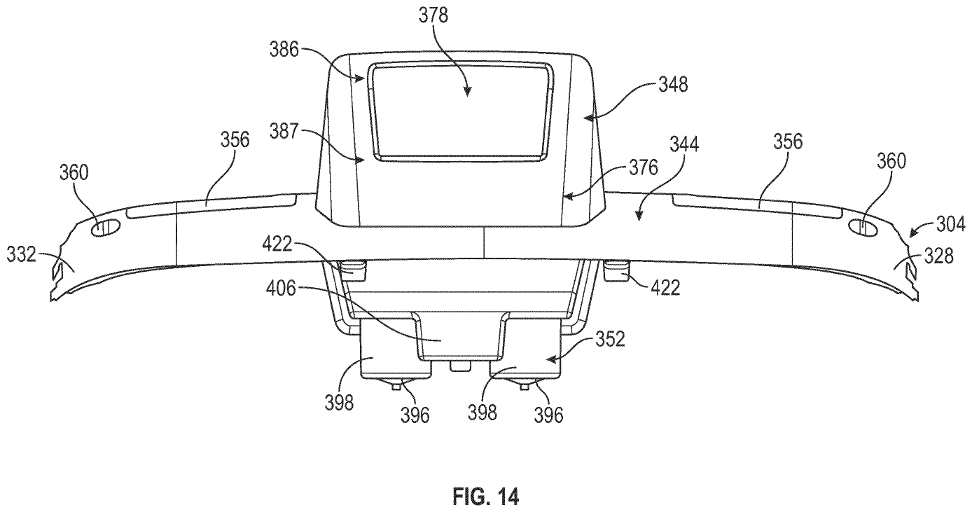

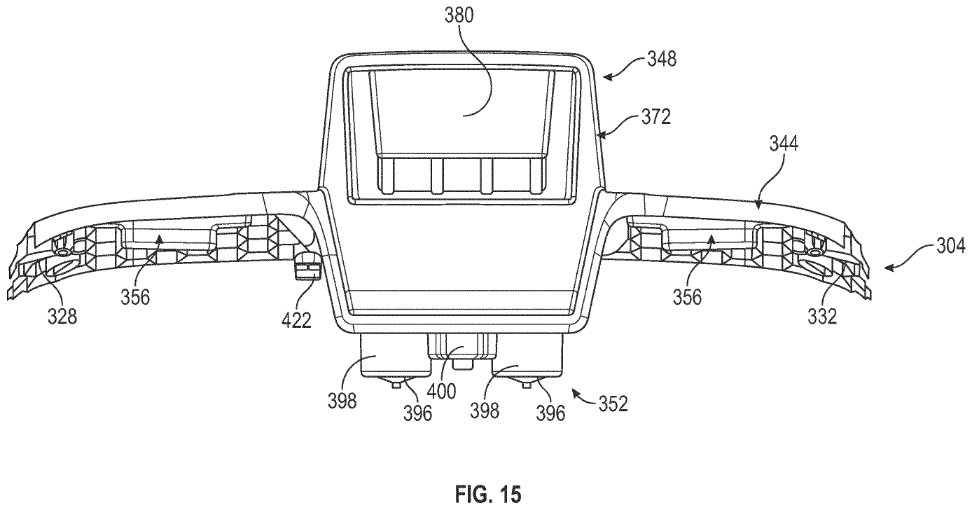

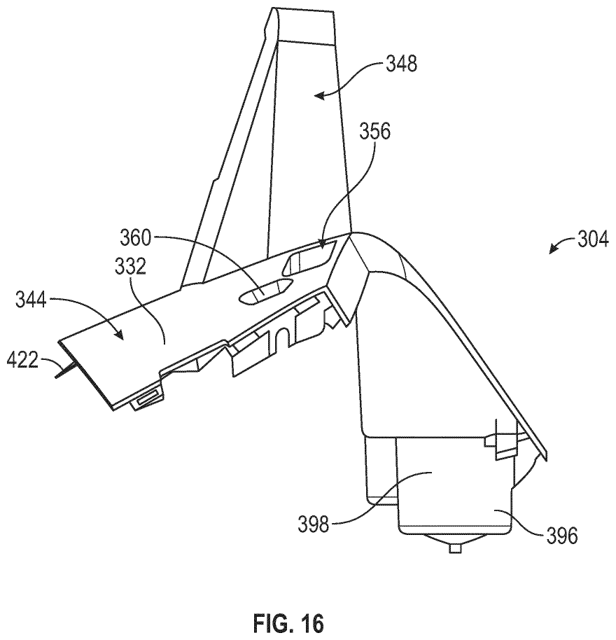

As shown in FIG. 4-7 and 12-16, the panel body 304 extends between a first end 328 and a second end 332. The panel body 304 includes a visible surface, shown as upper surface 336, and a hidden surface, shown as lower surface 340, opposite the upper surface 336. The upper surface 336 is visible to the passenger when the panel assembly 300 is couped to the cowl 24 and the lower surface 340 is hidden from the passenger when the panel assembly 300 is coupled to the cowl 24.

As shown in FIG. 4-7 and 12-16, the upper surface 336 includes a base portion, shown as dash portion 344; an interface enclosure, shown as housing 348; and a lower portion, shown as console portion 352. The dash portion 344 is configured to form a smooth seal with the cowl 24 and the occupant seating area 30. The dash portion 344 extends between the first end 328 and the second end 332. The housing 348 extends from the dash portion 344 in a first, upper direction. The housing 348 is configured to enable a passenger to access the operator interface 48. The console portion 352 extends from the dash portion 344 in a second, lower direction opposite the upper direction. The console portion 352 is configured to enable a user to store possessions (e.g., mugs, cups, cellphones, keys, etc.). Each of the housing 348 and the console portion 352 is centered along the console portion 352 (e.g., spaced substantially equidistance from the first end 328 and the second end 332, etc.).

As shown in FIGS. 4, 6, 7, and 12-16, the dash portion 344 includes or defines one or more device holders, shown as recesses 356, and one or more openings, shown as apertures 360. The recesses 356 are configured to retain a device (e.g., a cellular device, a phone, a mobile device, etc.) in (a) an upright position and (b) a horizontal position. The one or more apertures 360 are configured to receive a fastener to couple the panel body 304 to the cowl 24. The recesses 356 enable passengers to customize their device holding experience. For example, a passenger may want the device in the upright position to take a self-portrait with another passenger or want the device in the horizontal position to take a landscape photo of a golf course. In the illustrated embodiment, there are two recesses 356 spaced equidistant from a center of the housing 348. In some embodiments, there is only one recess 356. In some embodiments, there are more than two recesses 356 (e.g., three recesses 356, etc.). In some embodiments, the recesses 356 are offset from the center of the housing 348 at alternate distances. For example, one of the recesses 356 may be located closer to a center of the housing 348 than a second one of the recesses 356.

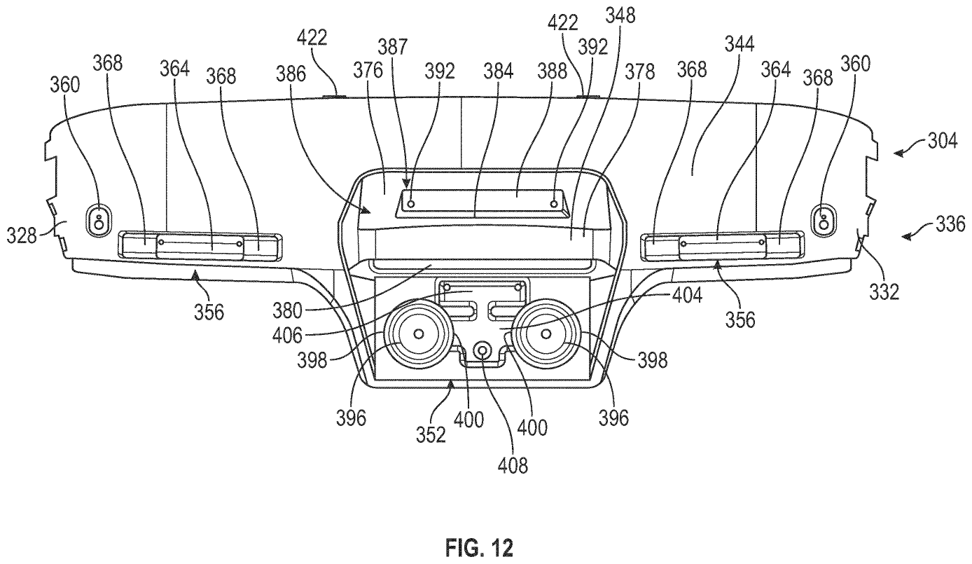

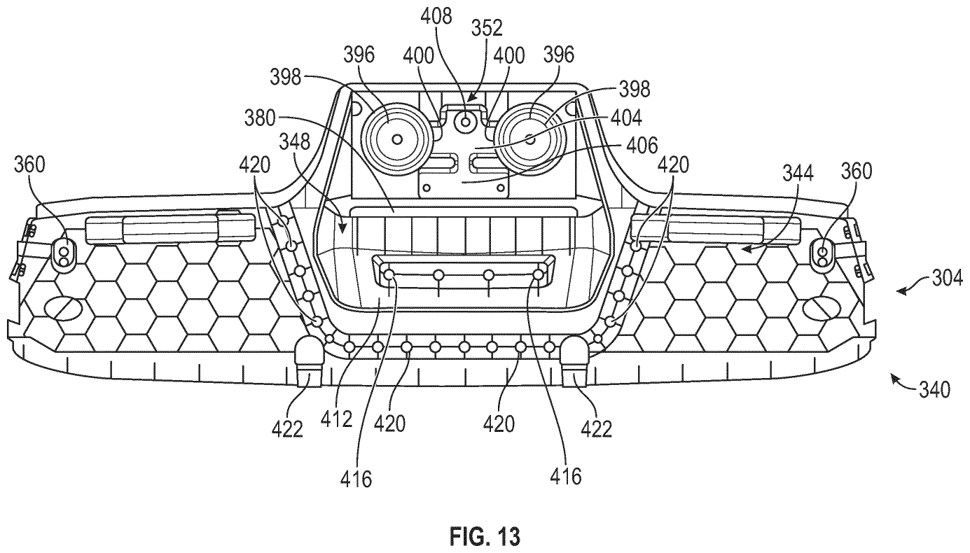

As shown in FIGS. 12 and 13, each of the recesses 356 includes a lower portion, shown as center portion 364, and a plurality of upper portions, shown as side portions 368. The center portion 364 is disposed between the side portions 368. The center portion 364 defines a first depth extending within the dash portion 344 and the side portions 368 defines a second depth extending within the dash portion 344. The first depth is greater than the second depth. Each of the recesses 356 is configured to retain the device in the upright position when the device is coupled to the center portion 364 and disposed between the side portions 368. Each of the recesses 356 is configured to retain the device in the horizontal position when the device is coupled to the side portions 368 and is offset from (e.g., disposed above) the center portion 364. Each of the recesses 356 is disposed between the housing 348 and one of the apertures 360.

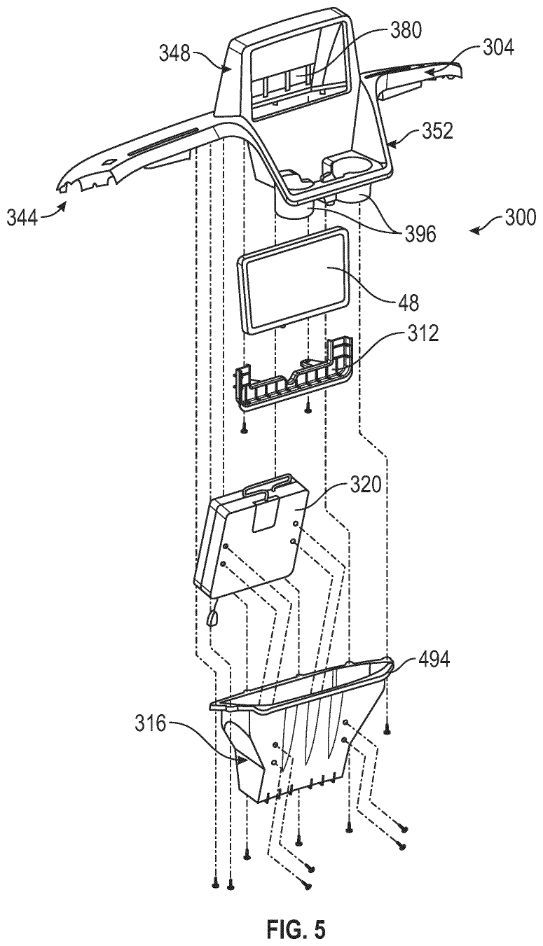

As shown in FIG. 12, the housing 348 includes a passenger facing surface, shown as front surface 372, a windshield facing surface, shown as back surface 376, and an upper surface, shown as top surface 378. The front surface 372 is opposite the back surface 376. Each of the front surface 372 and the back surface 376 extends from the dash portion 344 to the top surface 378. The front surface 372 is configured to face the occupant seating area 30 and the back surface 376 is configured to face the windshield 26. As shown in FIGS. 5, 12, 13, and 15, the front surface 372 includes or defines a front aperture, shown as first opening 380. The first opening 380 is configured to enable the passenger to access and interact with the operator interface 48.

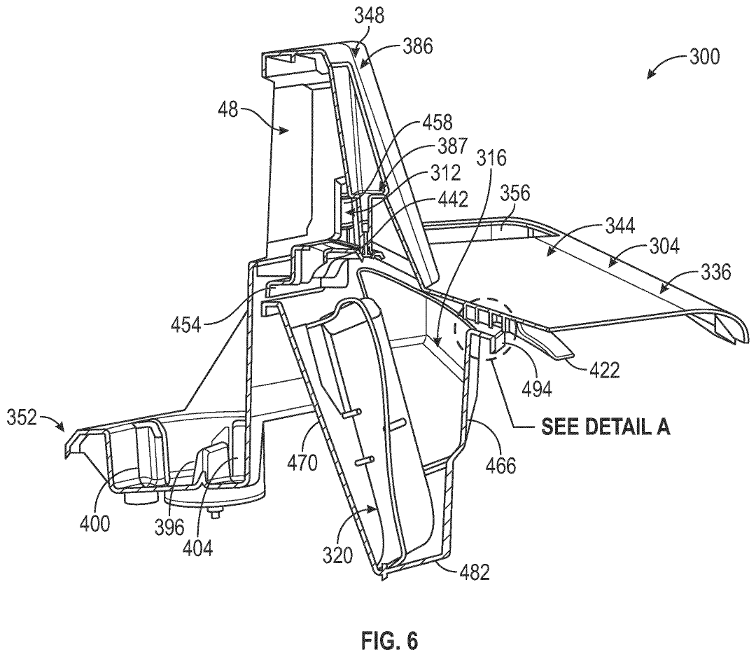

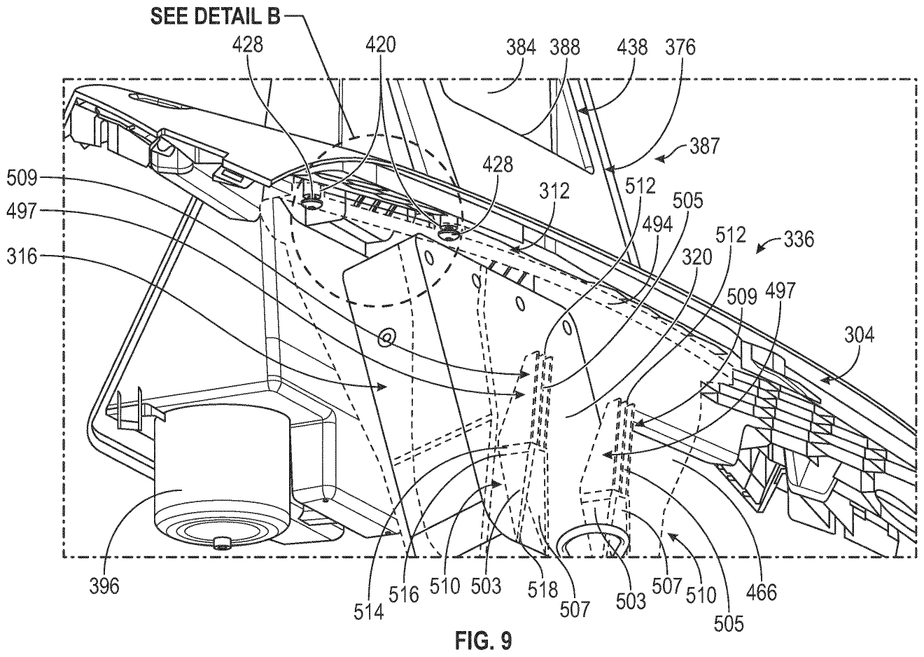

As shown in FIGS. 6, 9, 12, and 14, the back surface 376 includes or defines an indent or notched portion, shown as recess 384. The recess 384 extends between a first end 386 (e.g., a top end) and a second end 387 (e.g., a bottom end). A first distance is defined between the first end 386 and the top surface 378 and a second distance is defined between the second end 387 and the top surface 378. The second distance is greater than the first distance. As shown in FIGS. 9 and 12, the recess 384 includes a ledge, shown as ridge 388. The ridge 388 is disposed closer to the second end 387 than the first end 386 (e.g., the ridge 388 is located closer to the dash portion 344 than the top surface 378, etc.). As shown in FIG. 12, he ridge 388 includes one or more openings, shown as apertures 392. The ridge 388 and the apertures 392 are configured to receive an attachment (e.g., a foam piece, etc.) to prevent the windshield 26 from contacting the housing 348 and rattling (e.g., prevent positive interference, etc.). For example, the attachment may prevent ratting during operation of the vehicle 10, extreme weather events (e.g., high winds, etc.), or when the windshield 26 is bowed.

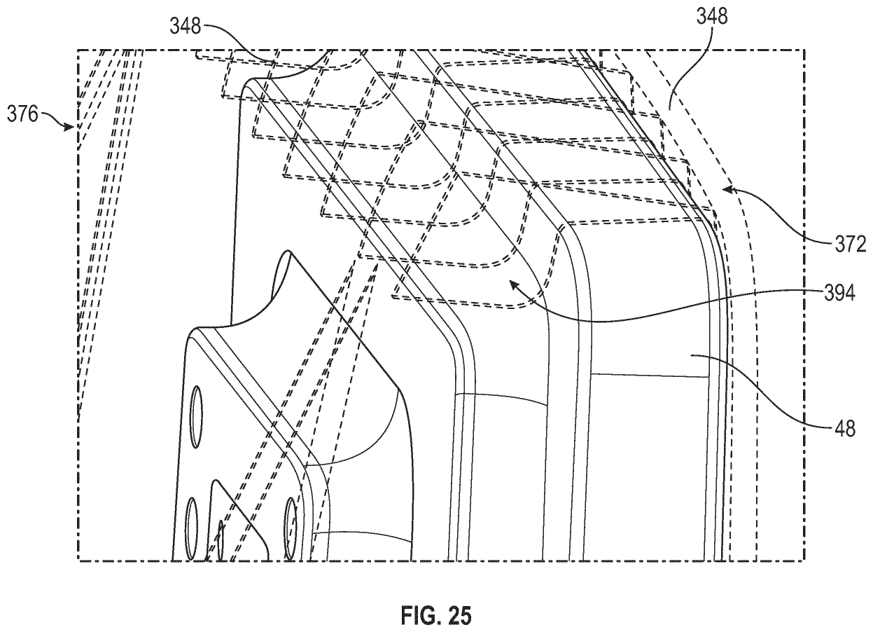

As shown in FIG. 25, the housing 348 includes one or more ridges, shown as ribs 394, extending between the front surface 372 and the back surface 376. A width of a portion of the ribs 394 contacting the back surface 376 is wider than a width of a portion of the ribs 394 contacting the front surface 372. The ribs 394 are configured to contact the operator interface 48, and push the operator interface 48 against the front surface 372. The ribs 394 prevent a gap from forming between the operator interface 48 and the front surface 372, enhancing the seamless appearance of the instrument panel assembly 300.

As shown in FIG. 4-7, 9, and 12-16, the console portion 352 includes or defines one or more cylindrical compartments, shown as first compartments 396; a center compartment, shown as second compartment 404; and a device compartment, shown as third compartment 406. The second compartment 404 extends between the first compartments 396 and the third compartment 406 is disposed rearward of and at least partially between the first compartments 396. The third compartment 406 extends rearward from the second compartment 404 toward the housing 348. A depth of the first compartments 396 is greater than a depth of the second compartment 404 and/or a depth of the third compartment 406. In the illustrated embodiment, there are two first compartments 396. In some embodiments, there is one first compartment 396. In some embodiments, there are more than two first compartments 396. For example, there may be three first compartments 396. As shown in FIG. 4-7, 9, and 12-16, each of the first compartments 396 is defined by a cylindrical wall 398. The cylindrical walls 398 each include a slot, shown as recess 400. The recess 400 enables a cup received within the first compartments 396 to extend within the second compartment 404. For example, a mug may be received within the first compartments 396 and a handle on the mug may extend through the recess 400 into the second compartment 404. The third compartment 406 is configured to receive a device in an upright position. In some embodiments, the third compartment 406 is configured as one of the recesses 356 in the dash portion 344 (e.g., the third compartment 406 may receive and retain the device in both the upright and horizontal position, etc.). The second compartment 404 defines an opening, shown as aperture 408, configured to receive a fastener to couple the panel body 304 to the cowl 24.

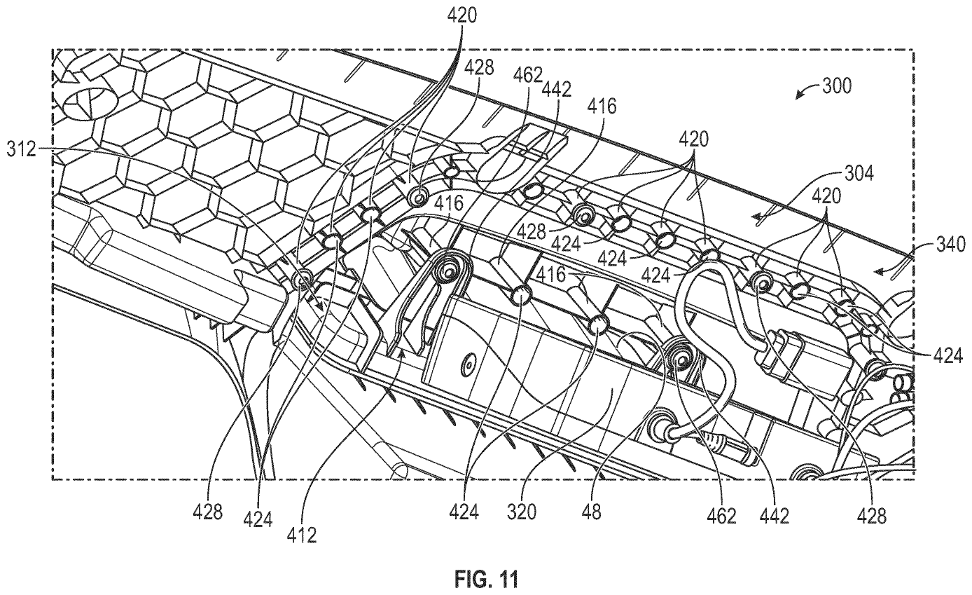

As shown in FIGS. 11 and 13, the lower surface 340 of the panel body 304 includes an aperture or slot, shown as second opening 412. The second opening 412 is disposed along the lower surface 340 of the housing 348 and is configured to receive the operator interface 48. For example, the operator interface 48 is slid (e.g., inserted, etc.) within the second opening 412 to install the operator interface 48 within the housing 348 and to be accessible through the first opening 380. The first opening 380 and the second opening 412 enable the panel assembly 300 to omit trim pieces to couple the operator interface 48 to the panel body 304. Eliminating trim pieces reduces visible seams and reduces the number of parts used in the panel assembly 300, reducing assembly time and maintenance costs (e.g., to store additional components, etc.).

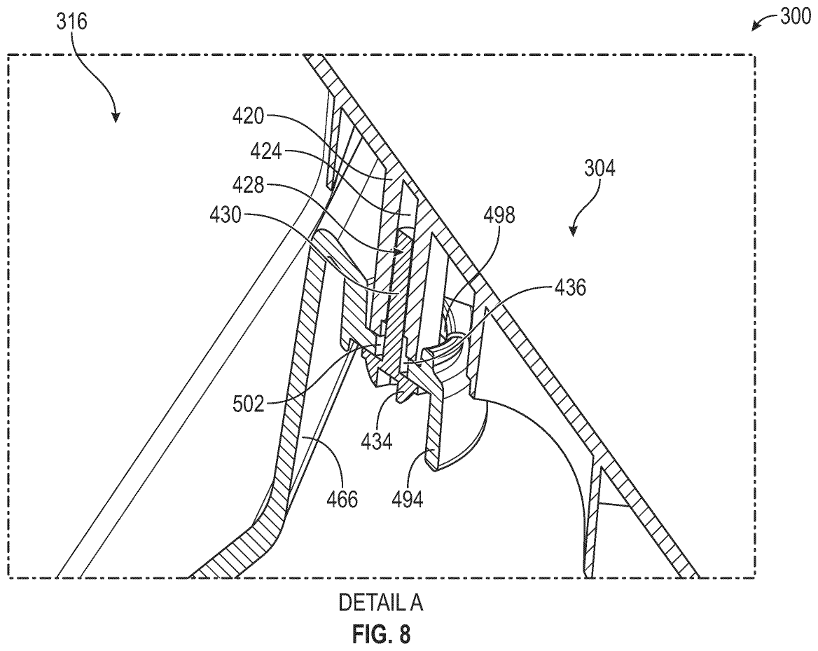

As shown in FIG. 8-11 and 13, the lower surface 340 of the panel body 304 includes a plurality of first flanges, shown as first bosses 416, and a plurality of second flanges, shown as second bosses 420. The first bosses 416 each extend from the lower surface 340 of the housing 348 toward the intermediate housing 312. The second bosses 420 each extend from the lower surface 340 of the panel body 304 toward the intermediate housing 312. The second bosses 420 are each disposed closer to the opening 412 than the first end 328 and the second end 332 of the panel body 304. The first bosses 416 are configured to couple the panel body 304 to the intermediate housing 312 and the second bosses 420 are configured to couple the panel body 304 to the lower housing 316. Each of the first bosses 416 and the second bosses 420 define an aperture 424 configured to receive a fastener.

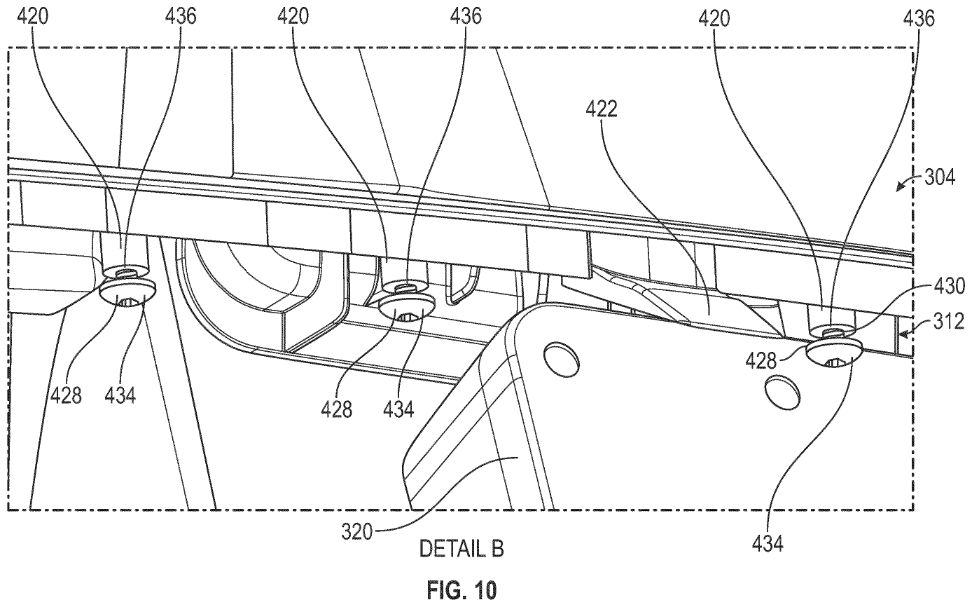

As shown in FIG. 10, a fastener 428 is received within the aperture 424 of each of the second bosses 420. The fastener 428 includes a shank, shown as base 430, and a head 434. A gap 436 is defined between the head 434 and an end of the corresponding second boss 420. The gap 436 is configured to receive a portion of the lower housing 316 to enable the lower housing 316 to hang from the panel body 304, as shown in FIG. 9.

As shown in FIGS. 6, 7, and 9-15, the lower surface 340 of the panel body 304 includes one or more alignment prongs, shown as tabs 422. The tabs 422 each extend from an edge of the lower surface 340. The tabs 422 are configured to couple the panel body 304 to and align the panel body 304 with the cowl 24. In the illustrate embodiment, the tabs 422 include two tabs 422 and the housing 348 is disposed between the two tabs 422.

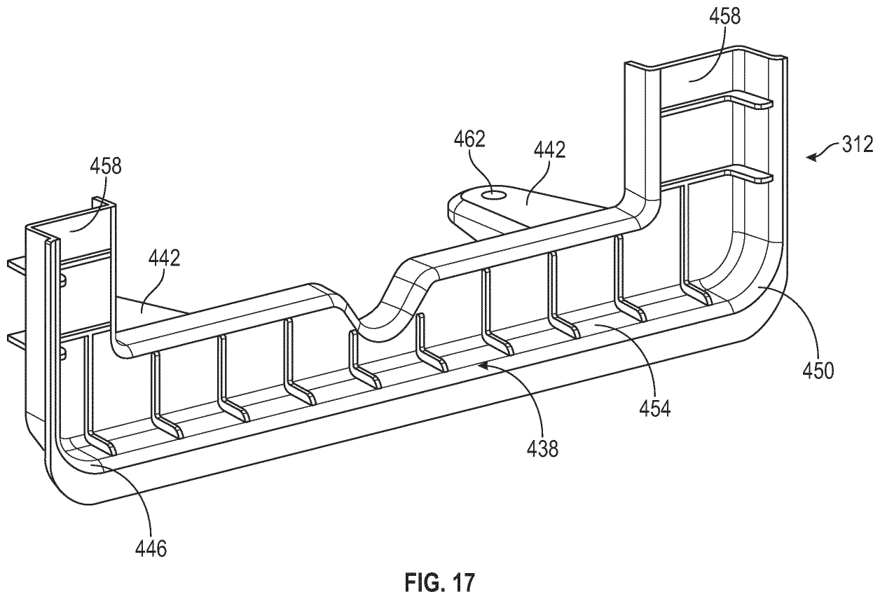

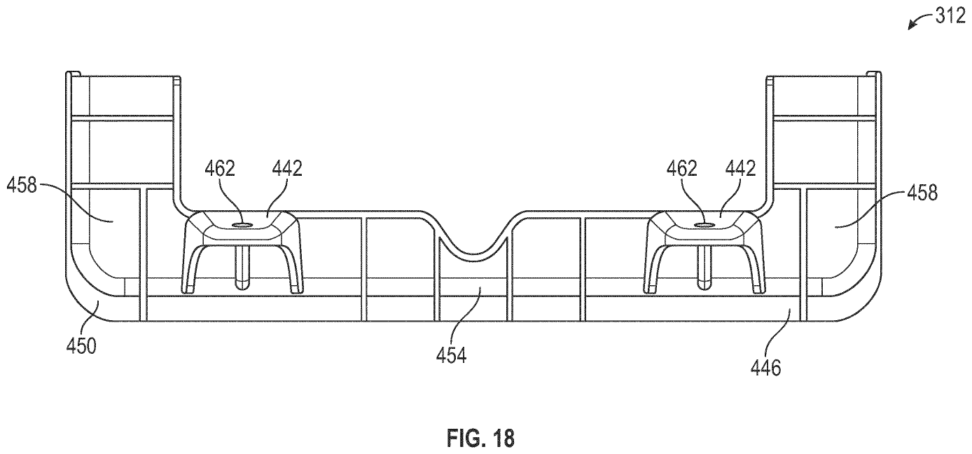

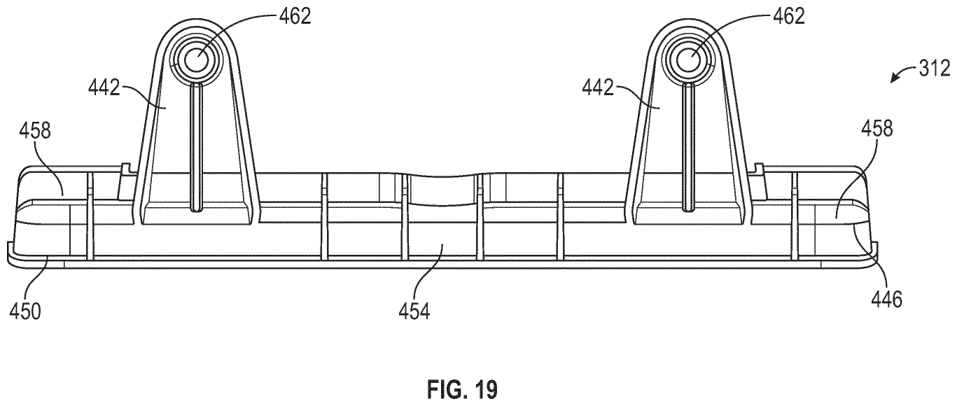

As shown in FIG. 17-19, the intermediate housing 312 includes a main portion, shown as base 438, and a plurality of projections, shown as prongs 442. Each of the prongs 442 extends substantially perpendicular to the base 438. The base 438 extends between a first end 446 and a second end 450. The base 438 includes a center portion, shown as middle portion 454, and side portions, shown as end portions 458. The end portions 458 extend from the middle portion 454. One of the end portions 458 extends from the first end 446 and one of the end portions 458 extends from the second end 450. Each of the end portions 458 is substantially perpendicular to the middle portion 454 and the prongs 442. Each of the plurality of prongs 442 defines an opening, shown as aperture 462, configured to receive a fastener to couple each of the prongs 442 to a corresponding one of the first bosses 416. Each of the apertures 392 along the ridge 388 are configured to align with the apertures 462 on the prongs 442. The ridge 388 enables a size of the fastener received within the aperture 462 and the apertures 392 to be reduced (e.g., to be shorter than without the ridge 388, etc.) and avoid sink marks on the housing 348. As shown in FIGS. 6, 9, and 10, the base 438 is configured to couple to the panel body 304 and wedges the operator interface 48 within the panel body 304, against the top surface 378 of the housing 348. The intermediate housing 312 prevents a gap from forming against the top surface 378 of the housing 348 and the operator interface 48, enhancing the seamless appearance of the instrument panel assembly 300.

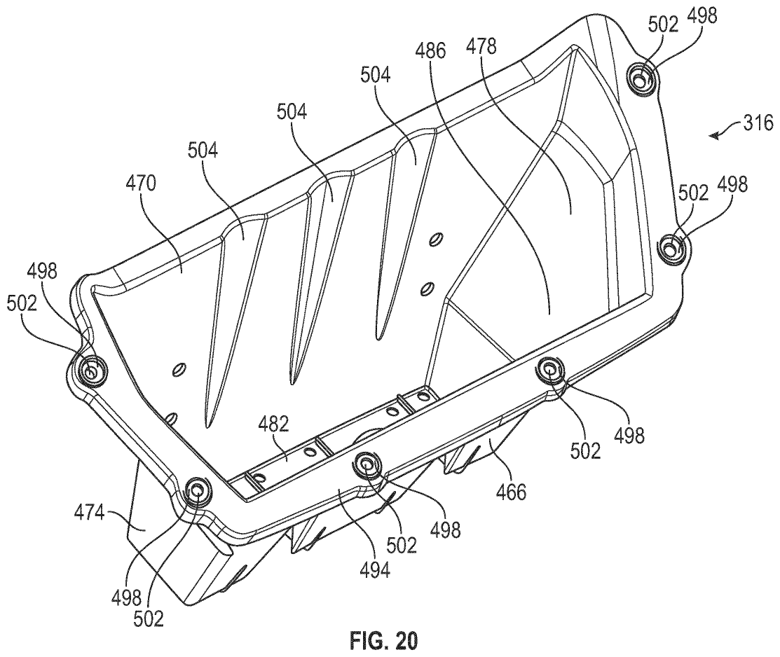

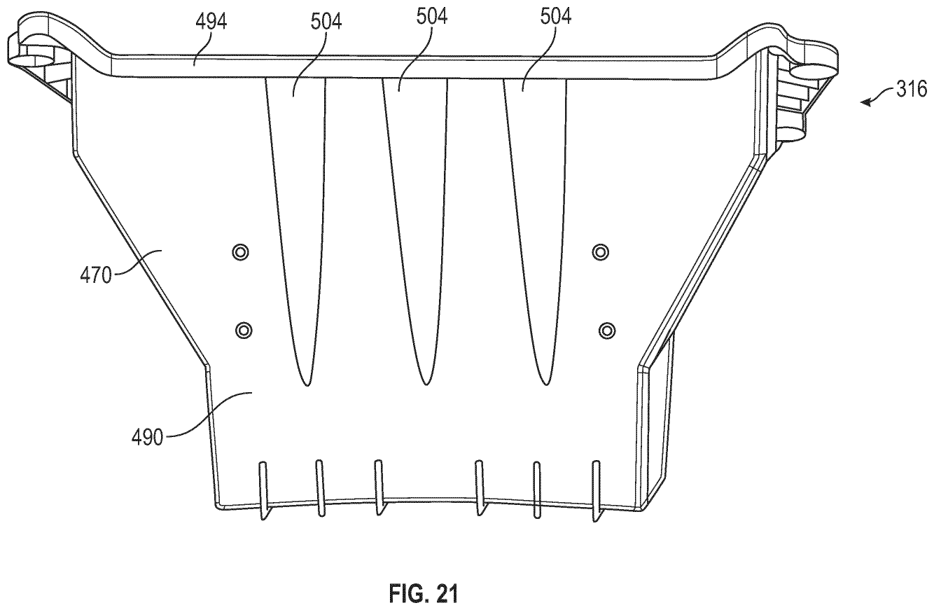

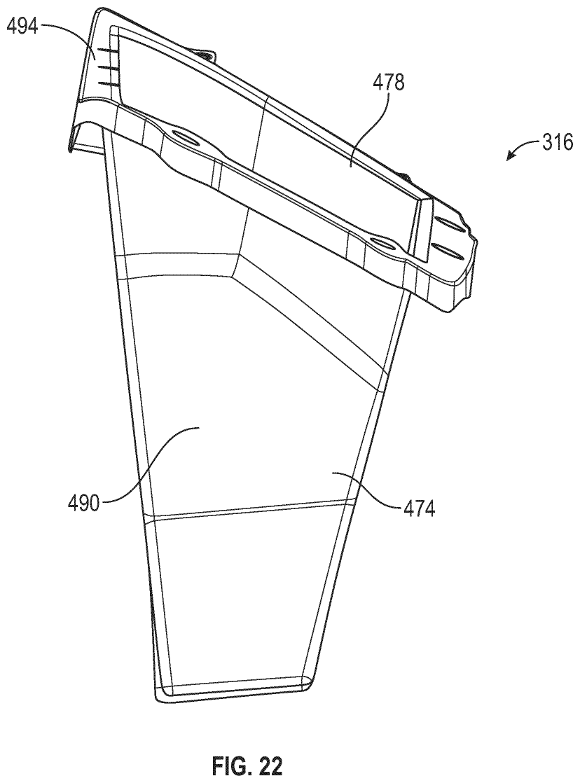

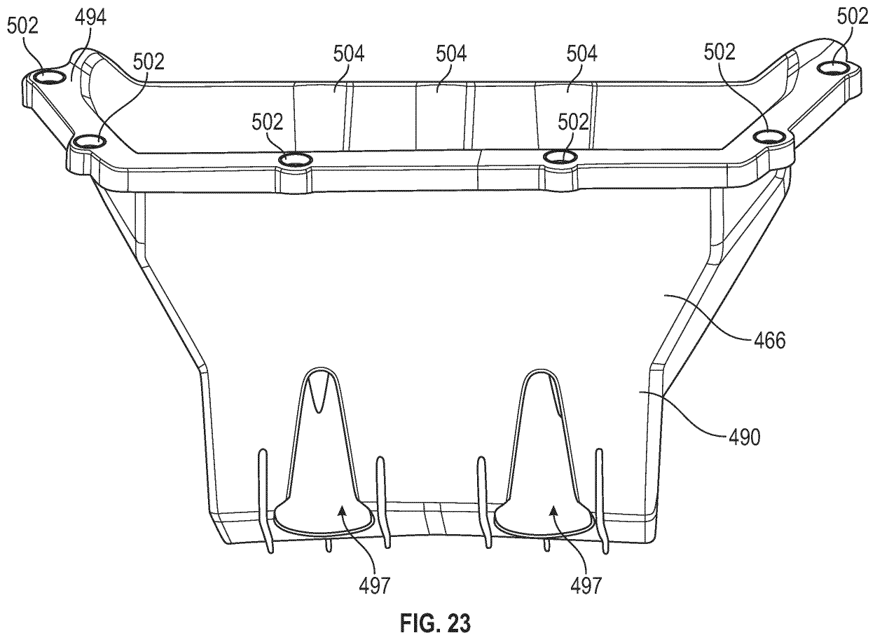

As shown in FIGS. 6, 7, 9, and 20-24, the lower housing 316 includes a back wall, shown as first side 466; a front wall, shown as second side 470; a left wall, shown as third side 474; a right wall, shown as fourth side 478; and bottom wall, shown as fifth side 482. The first side 466 is opposite the second side 470. The third side 474 is opposite the fourth side 478. The fifth side 482 extends between the first side 466, the second side 470, the third side 474, and the fourth side 478. Each of the first side 466, the second side 470, the third side 474, the fourth side 478, and the fifth side 482 include an interior surface, shown as inner surface 486, and an outer surface, shown as exterior surface 490. The inner surface 486 is opposite the exterior surface 490. The inner surfaces 486 of each of the first side 466, the second side 470, the third side 474, the fourth side 478, and the fifth side 482 are configured to face towards the controller 320.

As shown in FIG. 5-9, and 20-24 the lower housing 316 includes a rim 494 extending from an edge of the exterior surface 490 of the first side 466, the second side 470, the third side 474, and the fourth side 478. The rim 494 along each of the second side 470, the third side 474, and the fourth side 478 defines or includes one or more indents, shown as recesses 498, and/or one or more openings, shown as apertures 502. Each of the apertures 502 is centered on one of the recesses 498. As shown in FIG. 6-8, each of the recesses 498 is configured to receive one of the second bosses 420 to align the aperture 424 of the second boss 420 with the aperture 502 of the intermediate housing 312. The recesses 498 and the second bosses 420 reduce the assembly time of the panel assembly 300 (e.g., due to the auto-locating feature provided by the recesses 498 and the second bosses 420, etc.). As shown in FIGS. 8 and 9, the base 430 of the fastener 428 is received within the aperture 424 of the second boss 420 and the aperture 502 of the intermediate housing 312. The head 434 of the fastener 428 is coupled to the rim 494, and the gap 436 is aligned with and received by the aperture 502 of the rim 494. As shown in FIG. 9, the recesses 498 and the second bosses 420 enable the lower housing 316 to hang from the panel body 304 to position the lower housing 316 and the controller 320 directly under the operator interface 48.

As shown in FIGS. 9, 23, and 24, the first side 466 includes one or more rib sets 497 extending from the inner surface 486 of the first side 466 towards the inner surface 486 of the second side 470. Each of the rib sets 497 extends from the fifth side 482 towards a location located closer to the rim 494 than the fifth side 482. The rib sets 497 are configured to guide and align the controller 320 within the lower housing 316 so the controller 320 may be disposed directly beneath the operator interface 48. The rib sets 497 reduce the assembly time of the panel assembly 300 (e.g., due to the auto-locating feature provided by the rib sets 497, etc.). In the illustrated embodiment, there are two rib sets 497, the first rib set 497 spaced a first distance from the third side 474 and the second rib set 497 spaced a second distance from the fourth side 478 where the first distance may be substantially equal to the second distance.

As shown in FIG. 9, each of the rib sets 497 includes a first rib 503, a second rib 505, and a third rib 507. The second rib 505 is disposed between the first rib 503 and the third rib 507. The first rib 503 and the third rib 507 each extend from the fifth side 482. The third rib 507 is offset from the fifth side 482. Each of the first rib 503, the second rib 505, and the third rib 507 includes an upper portion 509. The upper portions 509 each form a substantially triangular perimeter. The upper portions 509 each include a first end 512 and a second end 514, the first end 512 closer to the rim 494 than the second end 514. The first end 512 defines a first width and the second end 514 defines a second width where the second width is greater than the first width.

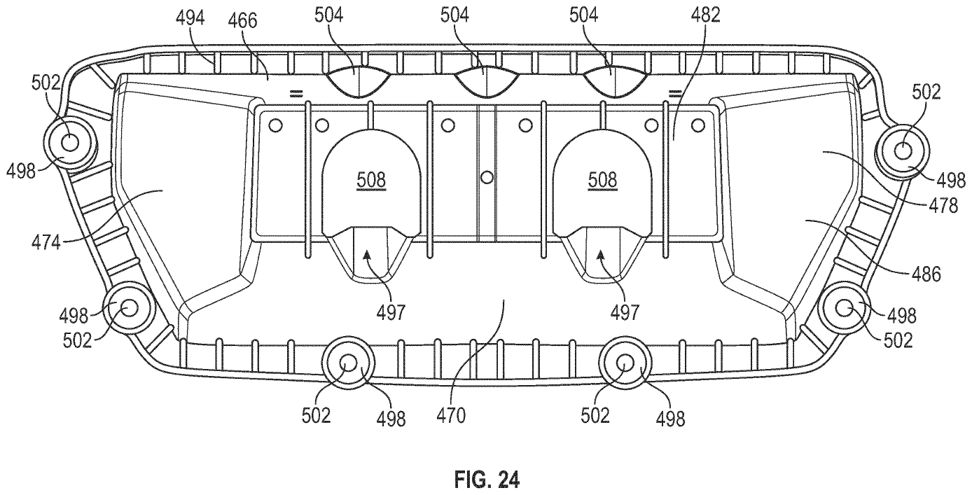

As shown in FIG. 9, the first rib 503 and the third rib 507 each include a lower portion 510. The lower portions 510 each form a substantially triangular perimeter. The lower portion 510 each extend between a first end 516 and a second end 518. The first end 516 of the lower portion 510 extends from the second end 514 of the upper portions 509 of the corresponding first rib 503, second rib 505, or third rib 507. The first end 516 of the lower portion 510 defines a third width and the second end 518 of the lower portion 510 defines a fourth width. The third width is substantially equal to the second width, and the fourth width is substantially equal to the first width. As shown in FIG. 24, in some embodiments, the upper portions 509 are omitted.

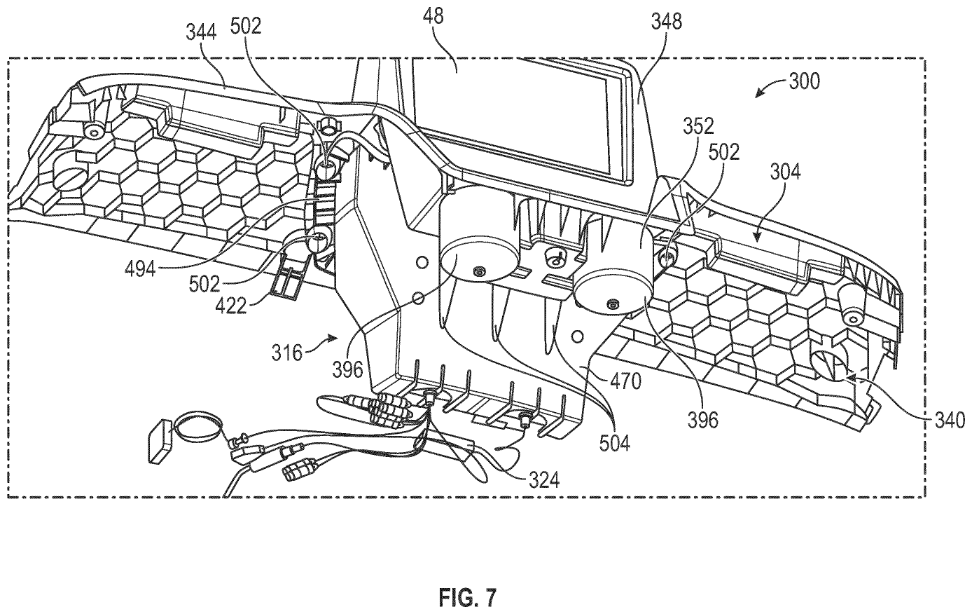

As shown in FIG. 24, the fifth side 482 defines one or more openings, shown as apertures 508. The apertures 508 are aligned with the one or more ribs 497 (e.g., a distance between a center of one of the apertures 508 and the third side 474 is substantially equal to a distance between one of the second ribs 505 and the third side 474, etc.). Each of the apertures 508 is configured to receive wiring 324, as shown in FIG. 7. The wiring 324 extends through the apertures 508 and couples to the controller 320. The rib sets 497 may also reduce the assembly time to align the apertures 508 with the controller 320 and couple the wiring 324 to the controller 320.

As shown in FIGS. 7, 20, 21, and 23, the inner surface 486 of the second side 470 defines one or more indents, shown as recesses 504. In the illustrated embodiment, there are three recesses 504. The recesses 504 extend from the rim 494 towards a location closer to the fifth side 482 than the rim 494. A width and a depth of a first end of the recesses 504 disposed adjacent the rim 494 is greater than a width and a depth of a second end of the recesses 504. In some embodiments, there is less than three recesses 504 (e.g., two, one, etc.). In some embodiments, there are more than two recesses 504 (e.g., three, four, etc.). The recesses 504 are configured to receive and align the controller 320 within the lower housing 316.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, and the vehicle control system 100, the panel assembly 300, etc.) as shown in the various exemplary embodiments is illustrative only. Additionally, any element disclosed in one embodiment may be incorporated or utilized with any other embodiment disclosed herein.

1. An instrument panel assembly for a vehicle, the instrument panel assembly comprising:
an instrument panel body including:
an upper surface defining a housing for receiving a display; and
a lower surface defining an opening to the housing, the display configured to be inserted through the opening, wherein when the instrument panel body is installed in the vehicle the upper surface is visible to a passenger, the upper surface configured to appear as a continuous unbroken surface; and
a lower housing configured to receive a controller for the display, the lower housing coupled to the lower surface of the instrument panel body;
wherein the display is received within the housing without any external trim pieces shrouding edges of the display.

2. The instrument panel assembly of claim 1, further comprising the display and the controller, wherein the controller is positioned under the display to enable the controller to be electrically coupled to the display.

3. The instrument panel assembly of claim 1, wherein the lower housing includes:
a first inner surface;
a second inner surface opposite the first inner surface; and
a plurality of ribs extending from the first inner surface towards the second inner surface, the ribs configured to engage with the controller.

4. The instrument panel assembly of claim 1, wherein the instrument panel assembly includes a display retainer received within the opening and disposed above the lower housing, the display retainer configured to support the display within the housing.

5. The instrument panel assembly of claim 4, wherein the display retainer includes:
a main portion configured to engage with the display; and
one or more prongs extending substantially perpendicular from the main portion.

6. The instrument panel assembly of claim 5, wherein the instrument panel body includes one or more bosses extending from an interior of the housing, each of the one or more bosses configured to couple to one of the one or more prongs of the display retainer.

7. The instrument panel assembly of claim 1, wherein the instrument panel body defines one or more recesses disposed along the upper surface, each of the one or more recesses configured to receive and retain a portable user device in (a) an upright position and (b) a horizontal position.

8. The instrument panel assembly of claim 1, wherein the opening is a first opening, and wherein the housing includes:
a first surface defining a second opening configured to enable the passenger to access the display; and
a second surface defining a recess, the second surface opposite the first surface, the second surface configured to confront a windshield of the vehicle, the recess configured to receive an attachment.

9. The instrument panel assembly of claim 8, further comprising:
a display retainer disposed within the first opening;
wherein a portion of the display retainer is configured to align with an aperture defined by the recess, the aperture configured to receive a fastener to couple the display retainer to the instrument panel body.

10. The instrument panel assembly of claim 1, wherein the instrument panel body includes:
a base portion, the housing extending from the base portion in a first direction; and
a console portion extending from the base portion in a second direction opposite the first direction.

11. The instrument panel assembly of claim 10, wherein the housing and the console portion are substantially centered along the base portion.

12. The instrument panel assembly of claim 10, wherein the base portion defines one or more recesses disposed along the upper surface, each of the one or more recesses configured to receive and retain a portable user device in (a) an upright position and (b) a horizontal position.

13. The instrument panel assembly of claim 10, wherein the console portion includes a first compartment defined by a cylindrical wall and a slot defined in the cylindrical wall.

14. The instrument panel assembly of claim 13, wherein the console portion includes:
a second compartment defined by a second cylindrical wall, a second slot defined in the second cylindrical wall;
a third compartment extending between the first compartment and the second compartment; and
a fourth compartment extending from the third compartment toward the housing, the fourth compartment configured to receive and retain a portable user device in an upright position.

15. The instrument panel assembly of claim 1, wherein the lower surface includes one or more prongs extending from an edge of the instrument panel body, the prongs configured to couple to a cowl on the vehicle.

16. The instrument panel assembly of claim 1, wherein:
the instrument panel body includes a plurality of bosses extending from the lower surface;
the lower housing includes:
a plurality of walls; and
a rim extending from the plurality of walls, the rim defining:
a plurality of recesses; and
a plurality of apertures, each of the plurality of apertures centered on one of the plurality of recesses; and
each of the plurality of recesses is configured to align one of the plurality of bosses with one of the plurality of apertures.

17. The instrument panel assembly of claim 16, wherein each of the plurality of apertures and each of the plurality of bosses is configured to receive a fastener, the fastener including:
a head; and
a shank extending from the head;
wherein a gap is defined between the head and an end of the boss, the gap configured to receive a portion of the rim.

18. An instrument panel assembly for a vehicle, the instrument panel assembly comprising:
an instrument panel body including:
an upper surface defining a housing for receiving a display; and
a lower surface defining an opening to the housing, the display configured to be inserted through the opening, wherein when the instrument panel body is installed in the vehicle the upper surface is visible to a passenger;
a lower housing configured to receive a controller for the display, the lower housing coupled to the lower surface of the instrument panel body, wherein the controller is positioned under the display to enable the controller to be electrically coupled to the display; and
a display retainer received within the opening and disposed above the lower housing, the display retainer configured to couple the display to the instrument panel body.

19. The instrument panel assembly of claim 18, wherein the display is received within the housing without any external trim pieces shrouding edges of the display.

20. A vehicle comprising:
a frame;
a cowl coupled to the frame;
a windshield coupled to the frame; and
an instrument panel assembly coupled to the cowl, the instrument panel assembly including:
an instrument panel body including:
an upper surface defining a housing for receiving a display, the housing including:
a first surface defining a second opening configured to enable a passenger to access the display; and
a second surface defining a recess, the second surface opposite the first surface, the second surface configured to confront the windshield, the recess configured to receive an attachment; and
a lower surface defining an opening to the housing, the display configured to be inserted through the opening, the lower surface including one or more prongs extending from an edge of the instrument panel body, the prongs configured to couple to the cowl, wherein when the instrument panel body is installed in the vehicle the upper surface is visible to the passenger; and
a lower housing configured to receive a controller for the display, the lower housing coupled to the lower surface of the instrument panel body.
